(19) United States
(12) Patent Application Publication
(10) Pub. No.: US 2024/0352157 A1
(43) Pub. Date: Oct. 24, 2024

(54) DISSOLUTION OF CHITOSAN IN APROTIC AQUEOUS MEDIUM COMPOSITION, PREPARATION METHODS AND BIOMEDICAL USES THEREOF

(71) Applicant: Oligo Médic inc, Laval (CA)

(72) Inventors: Abdellatif CHENITE, Kirkland (CA); Elias Assaad, Montréal (CA); Mélanie Dumont, Montréal (CA); Sam Alexandre Selmani, Montréal (CA); Cyril Chaput, Montreal (CA); Alexandre Moquin, Montréal (CA)

(21) Appl. No.: 18/495,033

(22) PCT Filed: Apr. 25, 2022
(86) PCT No.: PCT/CA2022/050626

§ 371 Date: Oct. 26, 2023

Related U.S. Application Data
(60) Provisional application No. 63/182,187, filed on Apr. 30, 2021.

(51) Int. Cl. C08B 37/08; C08J 3/05; C08J 3/075; C08J 3/24

(52) U.S. Cl. CPC C08B 37/003; C08J 3/05; C08J 3/075; C08J 3/24; C08J 2305/08

(57) ABSTRACT

It is provided a method and composition of chitosan, where the chitosan, independent of its molecular weight or degree of deacetylation, is dissolved in an acid free aqueous solution comprising charged aldehyde without the need of protonating agent, and wherein amino groups of chitosan form imine bonds with the aldehyde functions of the acid free aqueous solution making chitosan hydrophilic with negatively charged chains and resulting in chitosan particles being entrained in solution producing a acid free chitosan composition.

### CROSS-REFERENCE TO RELATED APPLICATIONS

The present application claims benefit of U.S. Provisional Application No. 63/182,187 filed Apr. 30, 2021, the content of which is hereby incorporated by reference in their entirety.

### TECHNICAL FIELD

The present description relates to a method for preparing water-soluble chitosan compositions under neutral and alkaline conditions, more specially at pH between 7.0 and 8.5, and novel chitosan derivatives obtained thereby.

### BACKGROUND

Chitosan is a linear polysaccharide obtained by alkaline deacetylation of chitin, the second most abundant natural polysaccharide after cellulose. It is composed of β-(1-4) linked 2-amino-2-deoxy-D-glucose and 2-acetamido-2-deoxy-D-glucose Chitosan refers to chitin derivatives having a degree of deacetylation (DDA) between 50 and 100%. NMR spectroscopy is seen as the most efficient method for determining the DDA, which represents the percent of acetamido transformed into amino groups Being a biocompatible, biodegradable and biologically active polysaccharide, it has been proposed tor a myriad of applications in pharmaceutical and biomedical fields. Its biodegradation leads to glucosamine and N-acetylglucosamine monomers and absorbable oligosaccharides.

It is well known that the solubilisation of chitosan with DDA comprising between 65% and 100% is limited to aqueous acidic media, which are able to give hydrogen proton (H+). Such dissolution necessarily implies the protonation of the amino groups to create positively charged chitosan chains, which by their mutual repulsions, are easily dissolved in aqueous media. Accordingly, making chitosan soluble in water under neutral pH is very challenging and appears unrealistic unless it is depolymerized to oligomers or homogeneously re-acetylated to a DDA between 40 and 65% or modified by covalently grafting a variety of hydrophilic substituents onto the chains. In the latter case, it is rather a derivative of chitosan that is obtained and not chitosan.

Solubility in water is an appropriate property of chitosan required for many biological applications, especially when it is used as antioxidants, antimicrobials and anticancer agents Presently, water-soluble chitosan synthesis is achieved primarily, either by modifying the chitosan backbone with hydrophilic molecules or by chains degradation to produce chitosan oligomers or by homogeneous reacetylation to yield chitosan polymers having DDA between 40 and 65% and where the acetyl groups are randomly distributed along the chains.

U.S. Pat. No. 4,996,307 describes the preparation of water-soluble chitosan having a degree of acylation between 35 and 65% obtained from water-insoluble random chitosan having a degree of deacetylation of at least 70% solubilized in an aqueous acidic solution. Kurita et al. (1991, Carbohydrate Polymers, 16: 83-92) also reported the preparation of water-soluble chitosan having a DDA around 50% by re-acetylating a 90% deacetylated chitosan using a mixture of aqueous acetic acid with methanol and pyridine. This method is considered impractical because of the use of pyridine in great excess

Lu et al. (2004, J. Appl. Poly, Sci., 91: 3497-3503) described an improved method for the preparation of water-soluble chitosan (WSC) through homogeneous N-reacetylation of chitosan having DDA of 83% and 90% with acetic anhydride. The authors discussed the effect of several factors, such as the amounts of reactants, acid concentration and the solvent used, on the yielded products. They found that among N-reacetylated chitosans, only those showing a DDA between 47 and 65% were soluble in water.

U.S. Pat. No. 7,683,039 teaches a method for preparing water-soluble chitosan by reintroducing acetyl randomly on both hydroxyl and amino groups. Even though the starting material was low molecular weight chitosan, a prior solubilisation in acidic medium was imperative to achieve the partial N-acetylation and the partial O-acetylation. The substitution degree of yielded products varied from 24 to about 55% on N-center and from 1 to about 60% on O-center.

Muzzarelli et al. (1982, Carbohydrate Research, 107. 199-214) discloses a process to synthesize N-carboxymethyl chitosan, using glyoxylic acid to dissolve chitosan (acidic conditions) followed by a reduction reaction with NaBH, at a pH between 4.0 and 6.3, wherein chitosan remains in solution when the pH is increased to 12 and that at neutral pH it is insoluble.

U.S. Pat. No. 10,857,176 teaches the transformation of a chitosan dispersion in aqueous solution of glyoxylate mixed with a hyaluronic acid without causing precipitation forming a gel like substance.

The depolymerisation method of water-insoluble chitosan is frequently adopted for the preparation of oligo-chitosan soluble in water, because it has little or no effect on the DDA. It could be achieved by physical, chemical or enzymatic treatments. In addition of being nontoxic and biocompatible, the so produced chito-oligomers exhibit numerous biological properties, including antioxidant, antibacterial, antifungal and antitumor activities, and they have been used as immune-enhancing agents in animals.

The chemical depolymerisation of chitosan is generally carried out through hydrolysis reaction mainly using concentrated HCl or nitrous acid, and oxidative-reductive reaction by hydrogen peroxide. Du et al. (2019, Advances in Materials Science and Engineering, 1-8) described a method for preparing water-soluble oligo-chitosan and low molecular weight chitosan by degradation using gamma irradiation in presence of hydrogen peroxide combined to N-reacetylation with acetic anhydride. The obtained products were proposed as efficient antioxidant agents. However, the enzymatic process for preparing chitosan oligomers remains the preferred one because the depolymerization is carried out under gentle conditions and the product formation can be controlled by means of pH, temperature and reaction time.

Other methods involving the modification of chitosan with hydrophilic molecules can yield water-soluble chitosan derivatives. Indeed, the products of these reactions are identified as chitosan derivatives insofar as hydrophilic molecules have been covalently bound to the polymer chains, often under severe reaction conditions (activator, catalyst, pH, temperature, etc.). Functionalization of the chitosan backbone with the carboxylic group or with a quaternary ammonium chloride are among the most popular strategies adopted for the preparation of water soluble derivatives of chitosan.

Moreover, the dissolution of chitosan is a critical step for transforming this biomaterial into hydrogels, films or foams for potential use as medical devices, and to create novel functional derivatives.

Acidic dissolution of chitosan poses a challenge and limitations to N-derivatization under homogeneous conditions due to partial protonation of amino groups.

Chitosan-based devices are continuously gaining increased attention as biomaterials for biomedical applications, such as tissue engineering and therapeutics delivery. Fu et al. (2018. New J Chem., 42: 1712-17180) provides a review of various strategies adopted for the fabrication of chitosan hydrogels in relation to the structure and mechanisms governing their intelligent behavior and accordingly, presently prior dissolution of chitosan in an acidic medium is mandatory for designing such hydrogels.

It is thus highly desired to be provided with a means to prepare chitosan compositions without prior dissolution in an acidic medium.

### SUMMARY

It is provided a method for dissolving chitosan in an acid free aqueous solution comprising charged aldehyde comprising the step of: suspending chitosan powder in the acid free aqueous solution at pH of at least 7, wherein the acid free aqueous solution is free of protonating agent, wherein amino groups functions of the chitosan form imine bonds with the charged aldehyde of the acid free aqueous solution making the chitosan hydrophilic with charged chains and resulting in chitosan particles being entrained in solution producing an acid free chitosan composition.

All expressions “charged aldehyde” or “aldehyde salt” or “organic salt bearing aldehyde” refer to organic molecule bearing both an aldehyde function (—CHO) and an ionized group. The later can be anionic group (carboxylate or phosphate) or cationic group (quaternary ammonium) or zwitterionic group (phosphocholine).

In an embodiment, the acid free chitosan composition has a pH between 7.0 and 8.5.

In a further embodiment, the acid free chitosan composition has a pH around 8.

In another embodiment, the acid free aqueous solution is an organic aldehyde salt aqueous solution.

In a further embodiment, the organic salt aqueous solution is a solution of an aldehyde bearing phosphate group or a solution of an aldehyde bearing phosphorylcholine group or a solution of an aldehyde bearing carboxylate group or a solution of an aldehyde bearing quaternary ammonium group.

In an additional embodiment, the acid free aqueous solution is a glycolaldehyde phosphate aqueous solution or a glyceraldehyde phosphorylcholine aqueous solution or a glycolaldehyde phosphocholine solution or a glyoxylate aqueous solution or carboxybenzaldehyde aqueous solution or an aldehyde betaine chloride aqueous solution.

In another embodiment, chitosan is solubilized in aqueous solutions of charged aldehydes to form either hydrogels or viscous solutions depending on the ratio of charged aldehyde with respect to amine of chitosan.

In a further embodiment, the method comprises reducing the chitosan-glycolaldehyde phosphate with NaBH4 to produce N-ethyl phosphate-grafted-chitosan.

In an embodiment, the aldehyde betaine chloride salt is N,N,N-trimethyl-2-oxoethanaminium chloride salt.

In a further embodiment, the method further comprises reducing the chitosan-aldehyde betaine mixture with NaBH4 to produce N-ethyltrimethylammonium chitosan.

In a further embodiment, the method further comprises the step of grafting or cross-linking the acid free chitosan composition.

In an embodiment, the acid free chitosan composition is in a liquid or gel-like from.

In an embodiment, chitosan-GAP solution or chitosan-GNa solution or

chitosan-CBA solution, is further transformed into an hydrogel with cross-linkers bearing at least two functions reactive toward amines.

In an embodiment, the cross-linker is a bifunctional reagent.

In an embodiment, the bifunctional reagent is a di-glycidyl ether (DGE) or a dialdehyde (Dal), or glycidyl trimethylammonium chloride.

In an embodiment, the bifunctional reagent is Polyethylene glycol diglycidyl ether (PEGDE), polyethylene glycol dialdehyde (PEGDAl) or glycidyl trimethylammonium chloride (GTMAC)

In an embodiment, LIOH is added to the mixture of chitosan-GNa generating an alkaline solution.

In an embodiment, chloroethanol is added to the alkaline solution producing a O-hydroxyethyl chitosan-Gna solution.

In an embodiment, the O-hydroxyethyl chitosan-Gna solution is acidified to produce O-hydroxyethyl chitosan and GNa.

In an embodiment, the Chitosan-GNa solution or chitosan-GAP solution of chitosan-CBA solution, is further transformed into an hydrogel with a multivalent cation.

In an embodiment, the multivalent cation, is at least one of Ca2+, Mg2+ and Fe2+.

In an embodiment, the chitosan as a molecular weight between 50 KD to 3000 KD and a degree of deacetylation from 65 to 100%.

### BRIEF DESCRIPTION OF THE DRAWINGS

Reference will now be made to the accompanying drawings.

FIG. 1 shows the rheological measurements recorded for chitosan-GAP gel-like solution (A) and liquid-like solution (B).

FIG. 2 illustrates the storage modulus (G′) and loss modulus (G″) versus frequency for a liquid solution in (A) and a gel-like solution in (B) of chitosan (CS, block chitosan, DDA=81%) in acid free aqueous solution with sodium glyoxylate (GNa).

FIG. 3 illustrates the gelation kinetic for chitosan/acid free medium and glycidyl trimethylammonium chloride (GTMAC) wherein the gel point is achieved at 56 min.

FIG. 4 displays 1H-NMR spectrum of chitosan-grafted-Ethyltriammonium chloride. Peak at position 3.57 ppm was assigned to H of trimethylammonium group.

FIG. 5 exhibits the presence of nanoparticles obtained by polyelectrolyte complexation of phosphate-N-grafted chitosan with trimethylammonium-grafted chitosan in solution as evidenced by the appearance of a solid laser beam.

### DETAILED DESCRIPTION

In accordance with the present description, there is provided a method and composition of chitosan, where the chitosan is dissolved in aqueous media in the absence of protonating agent, resulting in a solution having a pH around 8. The chitosan solution may be further grafted to create novel derivatives or cross-linked to form hydrogels suitable for biomedical applications.

The present description relates to a method for preparing water-soluble chitosan compositions under neutral and alkaline conditions, and more specially at pH between 7.0 and 8.5. These compositions are more amenable for derivatization and crosslinking than chitosan solutions prepared under acidic conditions.

The present disclosure relates to a method for dissolving chitosan in an acid free aqueous solution at pH comprised between 7.0 and 8.5. Under such pH, the amino groups of chitosan are more reactive, which makes possible the achievement of many crosslinking and modification reactions normally difficult or not possible to carry out under acidic pH when chitosan is dissolved in aqueous acidic solution, it provides an original concept for the development of new chitosan-based medical devices, prepared under mild and highly biocompatible conditions (neutral pH, low ambient reagent concentration). Indeed, the hydrogels prepared according to the method provided herein are suitable for biomedical applications. They can be used to encapsulate and deliver cells for tissue regeneration, such as cartilage and bone, and as active dressings for chronic wounds.

Another important feature of the chitosan composition described herein, is that chitosan does not precipitate even in strong alkaline environment. Those skilled in the art will understand that under such conditions the chitosan becomes more reactive toward electrophilic reagent by involving the alcoholate function rather than the amine function, because the alcoholate nucleophilicity is superior to that of the amine. As strongly supported by the experiment in Example 6, it is provided herein a new method for the preparation of O-hydroxyethyl chitosan derivative in a homogeneous aqueous medium. This in itself constitutes a significant breakthrough compared to all heterogeneous methods suggested in the prior art (see e.g. Shao et al., 2015, J. Ocean Univ. China (Oceanic and Coastal Sea Research), 2015, 14: 703-709; Wang et al., 2017, Carbohydrate Polymers. 2017, 167: 44-51; Nie et al., 2020. ACS Omega. 2020, 5: 10948-10957). The electrophilic reagent may be preferably selected from chloro-alcohol, such as chloroethanol, or from epoxide containing molecules, such ethylene oxide or epoxypropyl trimethyl ammonium chloride, without limitation.

The method comprises dissolving the chitosan powder in aqueous medium containing an organic molecule bearing both, an aldehyde function and a charged group. The latter can be a phosphate or carboxylate group (negative charge) or a quaternary ammonium group (positive charge) or a zwitterion group (positive and negative charges). The said organic molecule is preferentially selected from the following list, without limitation:

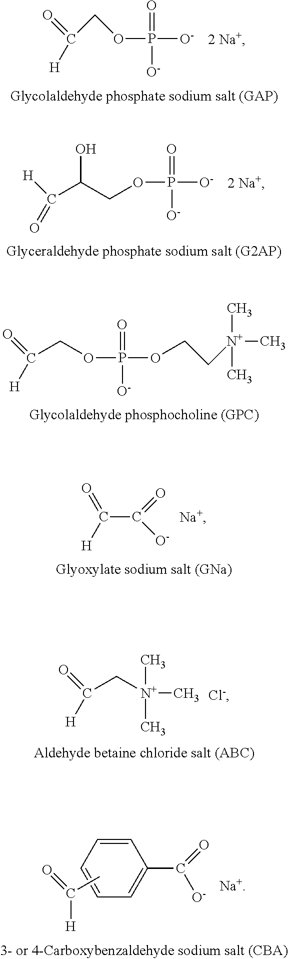

The aqueous solutions of these organic salts provide an environmental pH nearly physiological, where chitosan particles are entrained in solutions via their interaction with the aldehyde functions of the organic salts. Indeed, the amino groups of chitosan rapidly form imine bonds with the aldehyde function making chitosan polymer more hydrophilic as its chains becomes charged, either negative due to carboxylate or phosphate groups or positive due to quaternary ammonium group or positive and negative due to zwitterionic phosphocholine group. Although carboxylate or phosphate or quaternary ammonium or zwitterionic groups attach to the chitosan chains, this mechanism should not be confused with that involved in chitosan modification, since the imine bond is labile and can be easily displaced by more reactive functions or easily reversed to recover the original chitosan simply by adding water in great excess. To some extent, this behavior, i.e. chitosan recovery, is analogous to that when chitosan dissolved in acidic medium, via the protonation of the chains, is precipitated out in an alkaline medium following chains deprotonation.

The negatively charged aldehyde is sodium glycolaldehyde phosphate or sodium glyceraldehyde phosphate or sodium glyoxylate of sodium carboxybenzaldehyde. The positively charged aldehyde is betaine aldehyde chloride. And, the zwitterionic aldehyde is glycolaldehyde phosphocholine.

In an embodiment, the method provided herein comprises dissolving water-insoluble chitosan powder in a solution of sodium glycolaldehyde phosphate salt (GAP). The solubilisation is a consequence of the negative ionization conferred to chitosan chains via the fixation of phosphate group through the formation of imine bonds between the amines of chitosan and the aldehyde functions of the salt.

This particular interaction of chitosan with glycolaldehyde phosphate can lead to solutions or gels depending on the molar ratio of GAP with respect to chitosan's amino groups, as evidenced by rheological measurements shown in Figure

In an important embodiment, the obtained chitosan-imine glycolaldehyde phosphate solution-like or gel-like can be treated with NaHB₄, a reducing agent, to covalently bind ethyl phosphate to chitosan, thereby producing a novel chitosan derivative, a phosphate-grafted chitosan.

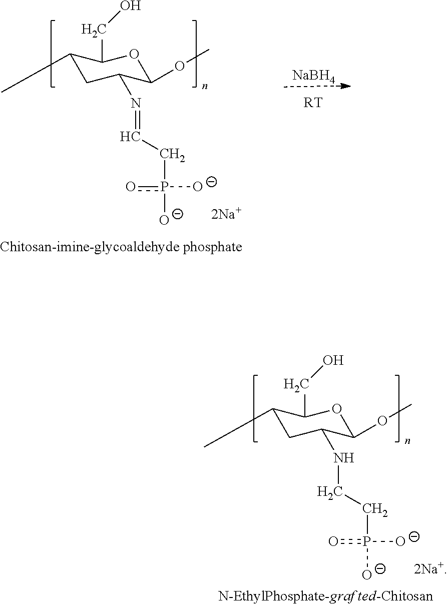

In another embodiment, the method provided herein comprises dissolving water non soluble chitosan powder in a solution of glyoxylate sodium salt (GNa). The solubilisation is a consequence of the negative ionization conferred to chitosan chains via the binding of glyoxylate through the formation of imine bonds between the amines of chitosan and the aldehyde function of the salt.

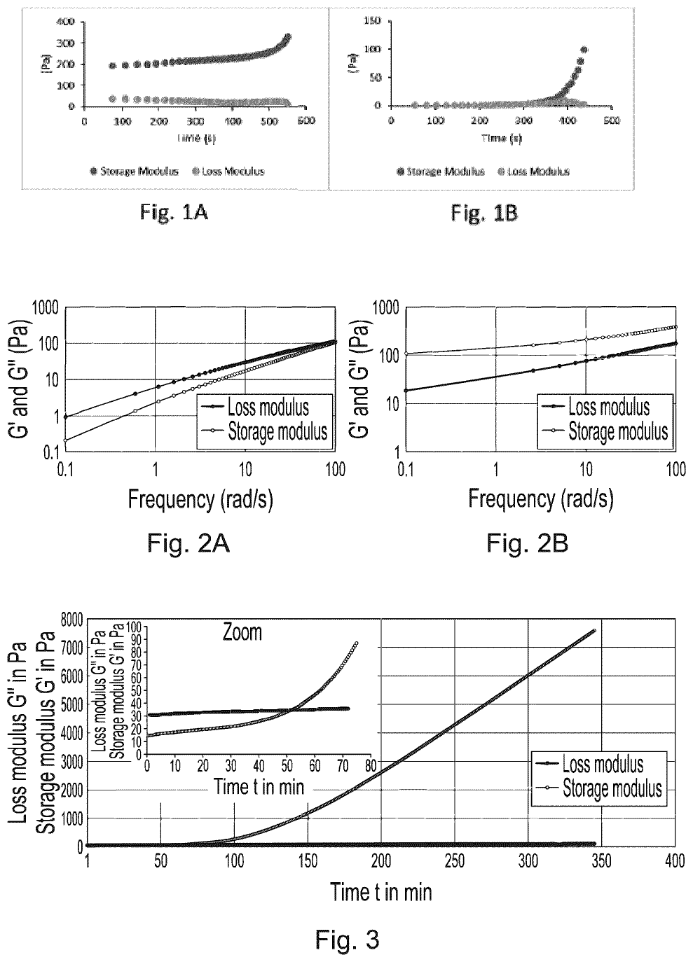

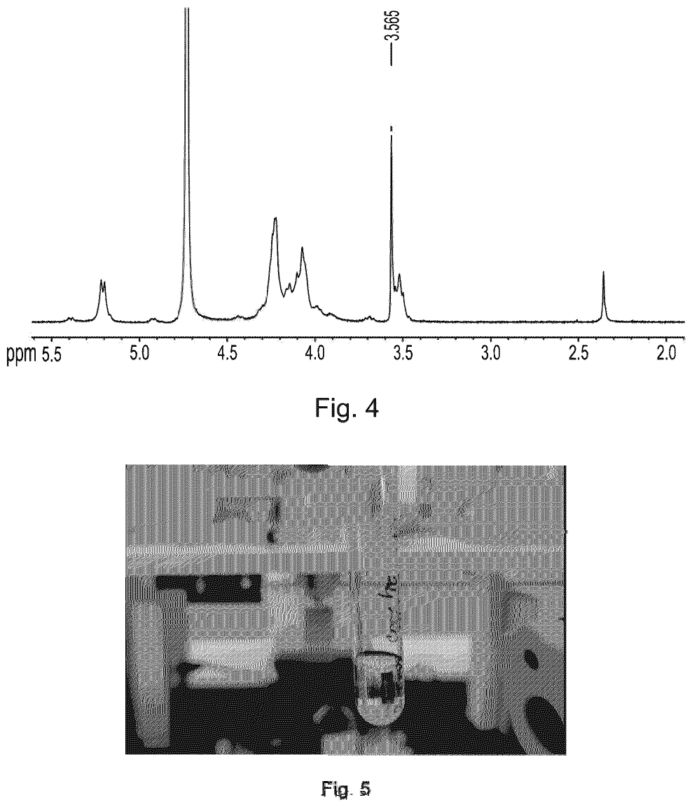

Contrary to U.S. Pat. No. 10,857,176, the method provided herein allow producing acid free chitosan solutions not restricted to gel-like compositions. In FIG. 1, it is displayed the rheological graphics evidencing liquid solutions (FIG. 1a) and gel-like solutions (FIG. 1b).

In another aspect, chitosan-GNa solution may be used to prepare O-hydroxyethyl chitosan under homogeneous conditions. Briefly, an amount of LiOH was added to chitosan-GNa solution to make it very alkaline. Then, a certain amount of chloroethanol was added to the alkaline solution, and allowed to react at R.T. during 24 hours. Under these conditions, the reaction took place between the alcoholate group of chitosan and the chloroethanol reagent to yield O-hydroxyethyl chitosan-Gna. The reaction medium was then acidified to approximately pH=3, to break the bond between O-hydroxyethyl chitosan and GNa. The O-modified chitosan may be recovered after precipitation in isopropanol followed by washing/dialysis in neutral water and freeze drying to obtain water soluble O-hydroxyethyl chitosan. It is thus provided a method of preparing O-modified chitosan that offers an improved alternative to the heterogeneous method, which required an ultra high alkalinity (50% NaOH) and a high temperature (90° C.), as indicated in the literature (Shao et al., 2015, J Ocean Univ. China (Oceanic and Coastal Sea Research), 2015, 14: 703-709; Wang et al., 2017, Carbohydrate Polymers, 2017, 167: 44-51; Nie et al, 2020, ACS Omega, 2020, 5: 10948-10957).

In another aspect, chitosan-GNa solution at neutral pH, may be transformed into a hydrogel by using cross-linking molecules bearing multi-functions reactive toward amine. The cross-linking molecules can be selected from di-glycidyl ether (DGE) or dialdehyde (Dal) or glycidyl trimethyl ammonium chloride, without limitation.

In another aspect, chitosan-GNa solutions at neutral pH, may be transformed into hydrogels by using, but not limited to, polyethylene glycol di-glycidyl ether (PEGDGE) or polyethylene glycol dialdehyde (PEGDAl) or glycidyl trimethylammonium chloride (GTMAC).

In another embodiment, chitosan-GNa solutions at neutral pH may form hydrogels following addition of soluble polyvalent cations, such as Ca²⁺, Mg²⁺, and Fe³⁺, without limitation.

In other embodiments, chitosan-GAP solutions may be used instead of chitosan-GNa solutions either, to prepare O-hydroxyethyl chitosan under homogeneous conditions or to prepare hydrogels at neutral pH using cross-likers as PEGDGE of PEGDAl or GTMAC or polyvalent cations such as Ca²⁺, Mg²⁺, and Fe³⁺.

Dissolving chitosan in an acid free aqueous solutions containing organic salts bearing aldehyde as disclosed herein allows to use chitosan at neutral pH without any restriction as to its molecular weight (Mw) or degree of deacetylation (DDA). Preferentially, they may be ranging 50 KD to 3000 KD for Mw and from 65 to 100% for DDA.

In one embodiment, the method provided herein comprises dissolving water-insoluble chitosan powder in a solution of aldehyde betaine chloride salt, N,N,N-trimethyl-2-oxoethanaminium chloride. The dissolution is a consequence of the positive ionization conferred to chitosan via the fixation of quaternary ammonium group through the formation of imine bonds between the amines of chitosan and the aldehyde functions of the salt.

In another aspect, the chitosan-imine betaine chloride has been further treated with the reductive agent NaBH, to link permanently betaine chloride to the chitosan chains. This may be considered as a new route to attach quaternary ammonium function by covalent bond to chitosan chain.

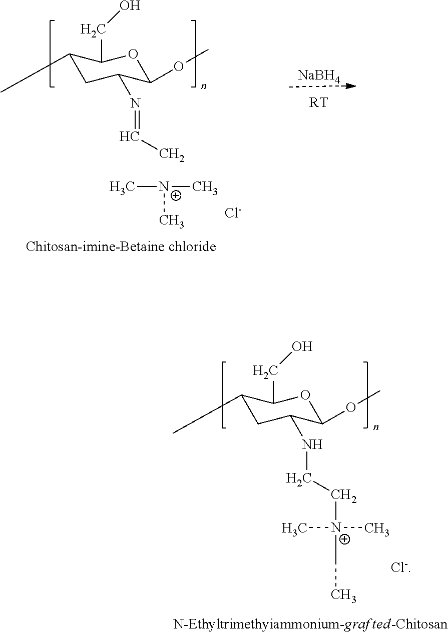

The method provided herein provides the solubilisation of chitosan through ionisation of its chains by non-permanent fixation of labile ions, carrying either negative or positive or zwitterionic charge. This approach is unprecedented and differs completely from the universally known one which, to dissolve chitosan, must carry out the protonation of chains with H⁺ ions using acidic media.

All properties recognized for chitosan are conferred on the solutions and hydrogels described herein. They are biodegradable, biocompatible, non-antigenic, non-toxic, biologically adhesive, biologically active, antimicrobial and hemostatic.

The chitosan solution described herein can be used as a hydrophilic coating solution to provide excellent lubricity and low friction to medical devices such as catheters, stents, guidewires, ocular implants and other implanted devices, in addition to conferring them antimicrobial properties.

In wound care, the chitosan-based hydrogels described herein can be designed to provide a moist environment to wounds, protect against secondary infections, absorb wound exudate, promote re-epithelialization and accelerate angiogenesis and collagen maturity. In tissue engineering, as they offer a physiological pH, these hydrogels can be proposed as carrier for cells, growth factors and stem cells to promote regeneration of cartilage or bone.

The methods of the present disclosure permit the creation of chitosan derivatives such as phosphate-grafted chitosan bearing high negative charge density and having a regular linear structure and strong buffering capacity at physiological pH. These derivatives can be employed for example to create nanocomplexes by combining with other polymers bearing positive charges.

The present disclosure will be more readily understood by referring to the following examples.

### Example I

### Chitosan Dissolution in Glycolaldehyde Phosphate Solution

### 1—Gel-Like Solution

In a typical experiment, precise amount, 0.205 g, of chitosan powder, with high molecular weight and DDA of 90%, was suspended in 10 mL of bicarbonate sodium solution (0.5M) containing 0.200 g of glycolaldehyde phosphate (GAP). After 1 hour the whole dispersed powder was completely dissolved resulting in Chitosan-GAP gel-like solution as evidenced by rheological measurements (FIG. 1A). The pH measurement indicated a pH value of about 7.6.

### 2—Liquid-Like Solution

In a second experiment, the rheological measurements, shown in FIG. 1B, indicated that the dissolution of 0.152 g chitosan in 10 ml of bicarbonate sodium solution (0.5M) containing 0.151 g of glycolaldehyde phosphate (GAP) led to chitosan-GAP liquid-like solution having a pH value around 7.8.

### 3—Covalent Binding of Ethyl Phosphate to Chitosan

Chitosan-GAP liquid-like solution prepared in the former example was subjected to reductive amination by adding dropwise 1 ml of NaBH4 aqueous solution (0.1 g/1 mL) under vigorous stirring. The resulting mixture was allowed to react at room temperature (RT) for 24 hours. Afterwards, the chitosan-grafted-ethyl phosphate was precipitated in isopropanol and then filtered to remove unreacted species. The precipitate was further purified by dialysis against acidic aqueous solution (pH-3) and recovered by lyophilization. The obtained chitosan-grafted ethyl phosphate, exhibited good water solubility at neutral and alkaline pHs.

### Example II

### Chitosan Dissolution in Glyoxylate Solution 0.099M

A precise amount, 0.215 g, of reacetylated chitosan (Medium Mw and DDA of 83%) in powder form was suspended in 10 mL of glyoxylate solution (0.099M) having a pH around 7. After 1 hour the whole powder was completely dissolved and the pH value of the resulting Chitosan-GNa or N-(carboxymethylidene) chitosan solution was measured around 7.5.

Viscosity of the resulting solution is about 18000 mPas. The evidence of obtaining a solution has been shown using rheology.

### Example III

### Chitosan-GNa-GTMAC Hydrogel

While maintaining stirring, 0.134 g of GTMAC were added to N-(carboxymethylidene) chitosan solution prepared in Example 1. A stiff hydrogel was formed after 24 hours at RT. The hydrogel formation has been shown to be temperature dependent as it formed in about 1 hour at 37° C. (FIG. 2) and in about 10 minutes at 50° C.

### Example IV

Chitosan-GNa Cross-Linked with DGPEG

While maintaining stirring, 0.289 g of DGPEG were added to a chitosan solution prepared according to Example III. Formation of stiff hydrogel after 24 hours at RT was observed.

### Example V

### Preparation of O-Hydroxyethyl Chitosan

Chitosan-GNa solution was prepared according to Example III. An amount 0.2 g of chitosan (Medium molecular weight and DDA 88%) was dissolved in 10 ml of glyoxylate solution (0.099M) and diluted with 10 mL of LiOH (4M). Then, chloroethanol was added dropwise under stirring. The reactional mixture was left to react at room temperature for 24 hours. After that, about 40 mL of HCl (1M) was added to decrease the pH between 3 and 4, and then about 60 mL of isopropanol is added to induce the precipitation of the polymer. The polymer was again dissolved in 10 mL of water and dialyzed against HCl solution (0.01M) to remove both glyoxylic acid and unreacted chloroethanol. The modified polymer recovered by lyophilization showed good solubility in water, which is an indicator that chitosan has been substantially O-hydroxyethylated as shown by 1H-NMR analysis.

### Example VI

### Chitosan Dissolution in Betaine Aldehyde Solution

A precise amount, 0.205 g, of chitosan powder was suspended in 10 ml of Betaine aldehyde chloride solution (28 mg/ml) having a pH around 7. After 1 hour the whole powder was completely dissolved and the pH of the resulting Chitosan-Betaine aldehyde solution was measured (pH=7.5).

Viscosity of the resulting solution is about 18 Pas. The obtaining of a solution has been evidenced using rheological measurements.

Chitosan used in this experiment has been obtained by reacetylation of completely deacetylated chitosan (100%). It has a medium molecular weight and degree of deacetylation (DDA) of about 83%, determined using 1H-NMR.

### Example VII

### Preparation of N-Ethyltrimethylammonium Chitosan

Chitosan-grafted-ethyltrimethylammonium chloride was obtained by reductive amination of chitosan-betaine aldehyde solution prepared according to Example 1. Briefly, chitosan (Low Molecular Weight and DDA 92%) was dissolved in aqueous solution of betaine aldehyde chloride (28 mg/mL). The pH of the resulting solution was first adjusted between 4 and 5. Then, 0. 2 g of NaBH4 dissolved in 1 mL of water was added dropwise under stirring. The resulting mixture was allowed to react at RT for 24 hours. Afterwards, the modified chitosan was precipitated in isopropanol and washed through dialysis in acidic aqueous solution (pH-3), then lyophilized to recover chitosan-grafted-ethyltrimethylammonium chloride as confirmed by ¹H-NMR spectrum of FIG. 3. The degree of grafted ammonium was evaluated to approximately 11%.

### Example VIII

Polyelectrolyte Complexation of Phosphate-Grafted Chitosan with Trimethylammonium-Grafted Chitosan

Nanocomplexes were obtained by mixing a solution of phosphate-grafted chitosan with a solution of trimethylammonium-grafted chitosan.

10 mg of phosphate-grafted chitosan sodium salt (MW about 250 kDa, high degree of substitution >60%) as obtained in Example 1.3 was dissolved in 10 ml of 0.9% physiological saline and added dropwise to a 60 mL solution of 0.9% physiological saline solution containing 60 mg of trimethylammonium-grafted chitosan (MW about 30 kDa). Nano-complexation was evidenced visually by the appearance of a characteristic pale blue tint and the visibility of a laser beam shone through the solution as shown in FIG. 5.

While the present disclosure has been described in connection with specific embodiments thereof, it will be understood that it is capable of further modifications and this application is intended to cover any variations, uses, or adaptations including such departures from the present disclosure as come within known or customary practice within the art and as may be applied to the essential features hereinbefore set forth, and as follows in the scope of the appended claims.

1. A method for dissolving chitosan in an acid free aqueous solution of charged aldehydes or aldehyde salts comprising the step of:
suspending chitosan powder in the acid free aqueous solution at pH of at least 7, wherein the acid free aqueous solution is free of protonating agent,
wherein amino groups functions of the chitosan form imine bonds with the aldehyde salts of the acid free aqueous solution making the chitosan hydrophilic with charged chains and resulting in chitosan particles being entrained in solution producing an acid free chitosan composition.

2. The method of claim 1, wherein the acid free chitosan composition has a pH between 7.0 and 8.5.

3. (canceled)

4. The method of claim 1, wherein the acid free aqueous solution is an organic aldehyde salt aqueous solution.

5. The method of claim 4, wherein the organic aldehyde salt aqueous solution is a solution of an aldehyde bearing phosphate group, a solution of an aldehyde bearing phosphorylcholine group, a solution of an aldehyde bearing carboxylate group, or a solution of an aldehyde bearing quaternary ammonium group.

6. The method of claim 1, wherein the acid free aqueous solution is a glycolaldehyde phosphate aqueous solution, a glyceraldehyde phosphate aqueous solution, a glycolaldehyde phosphocholine solution, a glyoxylate aqueous solution, a carboxybenzaldehyde aqueous solution, or an aldehyde betaine chloride aqueous solution.

7. The method of claim 1, further comprising the step of grafting or cross-linking the acid free chitosan composition.

8. The method of claim 1, wherein the chitosan is solubilized in an aqueous solution of charged aldehydes to form hydrogels or viscous solutions depending on the ratio of charged aldehyde with respect to amine of chitosan.

9. (canceled)

10. The method of claim 6, wherein the aldehyde salt is glycolaldehyde phosphate sodium salt (GAP); or the aldehyde betaine chloride salt is N,N, N-trimethyl-2-oxoethanaminium chloride salt.

11. The method of claim 6, further comprising reducing the chitosan-aldehyde GAP mixture with NaBH₄ to produce novel chitosan-N-grafted-ethyl phosphate.

12-13. (canceled)

14. The method of claim 6, wherein the chitosan-GAP solution, chitosan-sodium glyoxylate (GNa) solution or chitosan-sodium carboxybenzaldehyde (CBA) solution is further transformed into an hydrogel with cross-linkers bearing at least two functions reactive toward amines.

15. The method of claim 14, wherein the mixtures chitosan-GNa or chitosan-CBA are further transformed into hydrogels with cross-likers bearing at least two functions reactive toward amines.

16. The method of claim 15, wherein the cross-linker is a bifunctional reagent.

17. The method of claim 16, wherein the bifunctional reagent is di-glycidyl ether (DGE) or dialdehyde (Dal) or glycidyl trimethyl ammonium chloride.

18. The method of claim 17, wherein the bifunctional reagent is Polyethylene glycol diglycidyl ether (PEGDE), polyethylene glycol dialdehyde (PEGDAl) or glycidyl trimethylammonium chloride (GTMAC).

19. The method of claim 6, wherein LiOH is added to the mixture of chitosan-GNa generating an alkaline solution.

20. The method of claim 19, wherein chloroethanol is added to the alkaline solution producing a O-hydroxyethyl chitosan-GNa solution.

21. The method of claim 20, wherein the O-hydroxyethyl chitosan-GNa solution is acidified to produce O-hydroxyethyl chitosan and GNa.

22. The method of claim 6, wherein chitosan-GAP solution or chitosan-GNa solution or chitosan-CBA solution are further transformed into hydrogels with a multivalent cation.

23. The method of claim 22, wherein the multivalent cation is at least one of Ca²⁺, Mg²⁺ and Fe²⁺.

24. (canceled)

25. The method of claim 10, further comprising reducing the chitosan-aldehyde betaine mixture with NaBH4 to produce N-ethyltrimethylammonium chitosan.

26. (canceled)
